(19) United States
(12) Patent Application Publication
(10) Pub. No.: US 2021/0311687 A1
(43) Pub. Date: Oct. 7, 2021

(54) ELECTRONIC DEVICES AND METHODS OF OPERATING

(71) Applicant: Vestel Elektronik Sanayi ve Ticaret A.S., Manisa (TR)

(72) Inventor: Cagdas DÖNER, Manisa (TR)

(21) Appl. No.: 17/272,245

(22) PCT Filed: Aug. 31, 2018
(86) PCT No.: PCT/EP2018/073520

§ 371 Date: Feb. 26, 2021

(51) Int. Cl. G06F 3/14; G06F 1/26; G06F 1/16; H02J 50/10; H02J 50/90; H02J 7/34

(52) U.S. Cl. CPC G06F 3/1454; G06F 1/266; H02J 7/342; H02J 50/10; H02J 50/90; G06F 1/1698

(57) ABSTRACT

Induction coil located at a display screen of the electronic device is operated to wirelessly charge another device which is placed against or adjacent the display screen. Graphic content of the display screen of the electronic device that is obscured by the other device is sent to the other device for display by the other device whilst charging of the other device is taking place.

### TECHNICAL FIELD

The present disclosure relates to electronic devices and methods of operating electronic devices.

### BACKGROUND

Inductive charging (also called wireless charging) refers to the use of electromagnetic induction to transfer energy to a device so as to charge a battery of the device. For example, a mobile device, including for example a mobile phone, may be wirelessly charged using an induction charger. Induction chargers use an induction coil to create an alternating electromagnetic field. A second induction coil in the device to be charged takes power from the electromagnetic field and converts it back into electric current to charge the battery of the device.

### SUMMARY

According to a first aspect disclosed herein, there is provided a method of operating an electronic device, the method comprising: operating an induction coil located at a display screen of the electronic device to wirelessly charge another device which is placed against or adjacent the display screen; and sending, to the other device, graphic content of the display screen of the electronic device that is obscured by the other device for display by the other device whilst charging of the other device is taking place.

In an example, sending of the graphic content is performed in response to operating the induction coil to wirelessly charge the other device.

In an example, the graphic content is determined by determining a region of the display screen that is obscured by the other device whilst charging of the other device is taking place based on a location of the induction coil in the display screen, the graphic content being graphic content displayed in the obscured region.

In an example, the graphic content is determined by determining a region of the display screen that is obscured by the other device whilst charging of the other device is taking place by detecting at least one point of contact between the other device and the display screen, the graphic content being graphic content displayed in the obscured region.

In an example, the at least one point of contact is detected using at least one of: a touch sensor; an ultrasonic sensor; an infrared sensor; a proximity sensor; and a pressure sensor.

In an example, the obscured region is determined by detecting a point of contact between a first corner of the other device and the display screen of the electronic device and a point of contact between a second corner of the other device and the display screen of the electronic device.

The electronic device may send graphic content to the electronic device via at least one of a WiFi connection and a Bluetooth connection.

In an example, the graphic content is sent from a frame buffer of the electronic device to the other device.

According to a second aspect disclosed herein, there is provided an electronic device comprising: a display screen; and an induction coil located at the display screen for wirelessly charging another device which is placed against or adjacent the display screen in use; the electronic device being configured to send to said other device graphic content of the display screen that is obscured by said other device for display by said other device whilst charging of said other device is taking place.

In an example, the electronic device is configured to send the graphic content in response to operating the induction coil to wirelessly charge said other device.

In an example, the electronic device is configured to determine the graphic content by determining a region of the display screen that is obscured by the said other device whilst charging of said other device is taking place based on a location of the induction coil in the display screen, the graphic content being graphic content displayed in the obscured region.

In an example, the electronic device is configured to determine the graphic content by determining a region of the display screen that is obscured by said other device whilst charging of said other device is taking place by detecting at least one point of contact between said other electronic device and the display screen, the graphic content being graphic content displayed in the obscured region.

In an example, the electronic device comprises at least one sensor of: a touch sensor; an ultrasonic sensor; an infrared sensor; a proximity sensor; and a pressure sensor; and the electronic device is configured to detect the at least one point of contact using the at least one sensor.

In an example, the electronic device is configured to determine the obscured region by detecting a point of contact between a first corner of said other device and the display screen of the electronic device and a point of contact between a second corner of said other device and the display screen of the electronic device.

In an example, the electronic device is configured to send the graphic content from a frame buffer of the electronic device to said electronic device.

In accordance with a third aspect disclosed herein, there is provided a method of operating an electronic device, the method comprising: wirelessly charging the electronic device via an induction coil located in a display screen of another device when the electronic device is placed against or adjacent the display screen of the other device; receiving, from the other device, graphic content being displayed on the display screen of the other device and that is obscured by the electronic device whilst charging of the electronic device is taking place; and causing a display screen of the electronic device to display the received graphic content.

### BRIEF DESCRIPTION OF THE DRAWINGS

To assist understanding of the present disclosure and to show how embodiments may be put into effect, reference is made by way of example to the accompanying drawings in which:

FIGS. 1a and 1b shows schematically an example of an electronic device charging another electronic device in accordance with examples described herein;

FIG. 2 shows a flowchart illustrating a method in accordance with an example described herein; and

FIGS. 3a and 3b show schematically the determination of an obscured display screen area in accordance with an example described herein.

### DETAILED DESCRIPTION

As mentioned above, electronic devices may be equipped with wireless charging capabilities. This means they have an internal induction coil which can receive power wirelessly via an induction coil in a charging station or the like. In order for a user to charge an electronic device, the electronic device is placed within the proximity of the charging station which can then wirelessly transfer power to the electronic device via electromagnetic induction. This type of charging is also referred to as wireless charging.

The charging station itself is typically a standalone device upon which the user can place the electronic device. The user must therefore keep the charging station for use when required. However, this is inconvenient, as it requires the user to keep yet another device (the charging station) which is only used occasionally. It would be desirable to be able to wirelessly charge an electronic device without requiring a dedicated, separate charging station.

In examples described herein, an induction coil is located at a display screen of an electronic device which can be operated to wirelessly charge another device which is placed against or adjacent the display screen. This is advantageous because it does not require the user to have a dedicated, separate charging station. Instead, the user is able to charge their device by simply placing it against the display screen of the electronic device. At the same time, graphic content of the display screen of the electronic device that is obscured by the device that is being charged is sent to that device for display by that device whilst charging is taking place. The device being charged then uses this received graphic content in order to replicate the obscured graphic content. This means that the user can then still view the content which would otherwise have been blocked by the device being charged.

Another advantage of this is that the device can be charged without requiring use of a port (e.g. a USB port) to receive power. This therefore frees up a port, allowing an extra peripheral device to be connected, or saves costs by not requiring a charging port to be provided.

Yet another advantage is that the device can be charged without substantially interfering with operation of the charging electronic device. This is because the blocked portion of the display screen of the charging electronic device is replicated by the device being charged, hence minimising the impact of the device being in the way of the display screen. This arrangement also means that the device can be charged without interfering with any other important user interface points (such as a keyboard, a trackpad, etc.).

Also, in the case that the charging electronic device is a laptop computer or similar device that has a keyboard or the like, it is often the case that the region underlying the keyboard is slim and crowded with components (such as processors, memory, a hard disk or solid state drive, etc.) and there is no space for an induction coil. In accordance with the present disclosure, the induction coil is located in the display screen of the charging device, where there is space for the induction coil to be located.

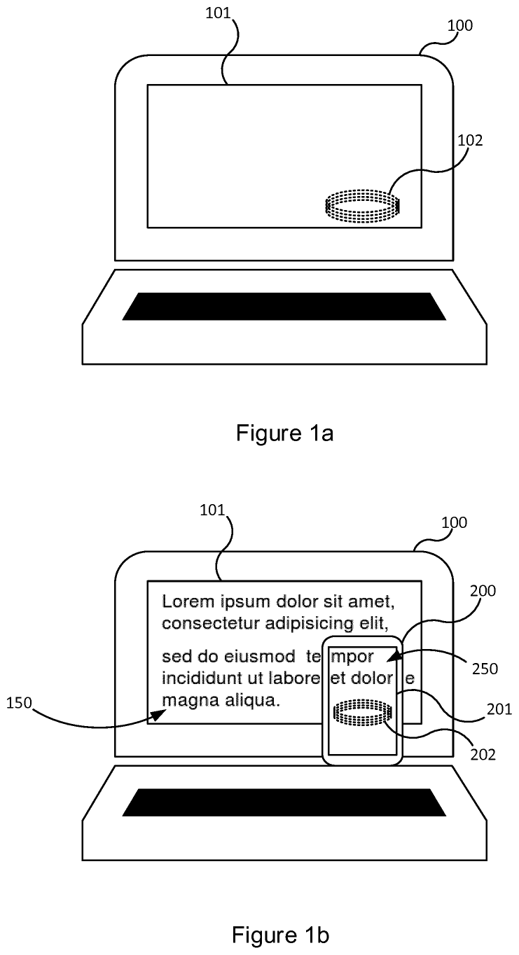

Referring now to the drawings, FIG. 1a shows schematically an electronic device 100 according to an example of the present disclosure. The electronic device 100 has a display screen 101 for displaying graphic content (explained in more detail below in relation to FIG. 1b). The display screen 101 may be provided integrally with the electronic device 100, as in the example shown, or as a separate screen which is connected to the electronic device 100 via a wired or wireless connection. In this example, the electronic device 100 is a laptop computer.

An induction coil 102 is located at the display screen 101. A typical display screen, such as an LCD (liquid crystal display), LED (light emitting diode), OLED (organic light emitting diode), etc. screen, may comprise a plurality of layers (such as polarizing filters, diffusers, etc.). It is not necessary that the induction coil 102 is located immediately behind the front display surface of the display screen 101, because the electromagnetic field generated by the induction coil 102 is able to penetrate such layers. Hence, the induction coil 102 may be embedded within the body of the display screen 101 or located behind the display screen 101 itself. The induction coil 101 may even be located behind the housing of the display screen 101.

The induction coil 102 can be controlled by a processor of the charging device 100 to provide wireless charging capabilities. That is, the induction coil 102 is arranged within the charging device 100 to receive an alternating current, from for example a mains power supply and possibly via a suitable transformer, in operation. Although shown as a laptop computer in FIGS. 1a and 1b, the charging device 100 may be another type of electronic device such as a desktop computer, a tablet computer, etc., as long as they have or are connected to a display screen at which an induction coil can be located.

FIG. 1b shows a device 200 to be charged placed on the display screen 101 of the charging device 100. The device 200 to be charged comprises a second induction coil 202 for the purposes of wireless charging, i.e. for wirelessly receiving power from a primary induction coil such as the induction coil 102 located in the charging device 100. The device 200 to be charged has a rechargeable battery (not shown). The device 200 to be charged comprises a display screen 201 for displaying graphic content. In this example, the device 200 to be charged is a phone such as a smartphone. In other examples, the device 200 to be charged is some other device, particularly a mobile device, that has a rechargeable battery and a display screen, including for example a tablet computer or personal digital assistant (PDA), etc.

The device 200 to be charged is placed on the charging device 100 such that it is within wireless charging range of the induction coil 102. The wireless charging range depends on properties of the induction coil 102, the device 200 to be charged and the materials present in the display screen 101 of the charging device 100 in accordance with known physical laws. Generally, it is not necessary to place the device 200 to be charged precisely on the display screen 101 of the charging device 100 to achieve wireless charging. Instead, the device 200 to be charged may be placed against or adjacent to the display screen 101 of the charging device 100.

The device 200 to be charged, when placed on the display screen 101 of the charging device 100 for wireless charging, will block the user's view of at least a portion of the display screen 101 of the charging device 100. This is solved by the charging device 100 sending graphic content to the device 200 being charged for the device 200 being charged to render on its display screen 201, as shown schematically and by way of example in FIG. 1b. As long as the device 200 being charged is placed “face up” (i.e. with the display screen 201 of the device 200 being charged facing away from the display screen 101 of the charging device, towards the user), then the device 200 being charged can be used to emulate the blocked portion of the display screen 101 of the charging device 100.

In the example shown in FIG. 1b, the display screen 101 of the charging device 100 is displaying graphic content 150. The display screen 201 of the device being charged is used to display a portion 250 of the graphic content 150 and to thereby minimise visual impact of the device 200 being charged from the user's perspective. To do so, the device 200 being charged receives some graphic content from the charging device 100, which is to be displayed on the display screen 201 of the device 200 being charged. This enables the display screen 201 of the device 200 to “match” the graphic content that is being displayed on the display screen 101 of the charging device 100 and that is behind the device 200. Example methods by graphic content to be displayed by the display screen 201 of the device 200 being charged is determined are given below.

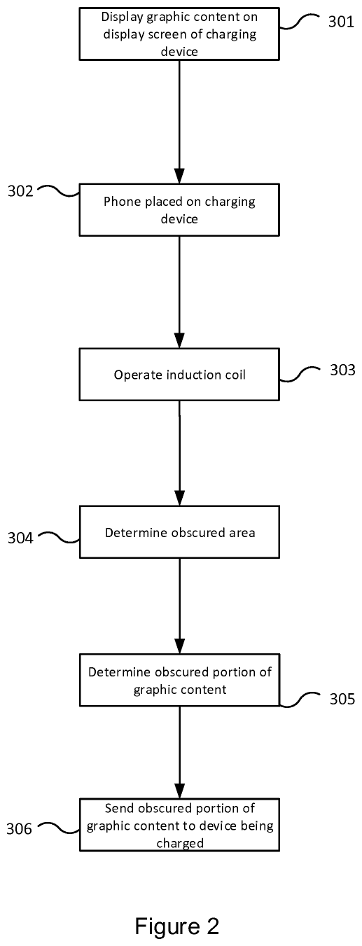

FIG. 2 show a flowchart of a method in accordance with an example described herein.

At 301, the charging device 100 is displaying graphic content 150 on the display screen 101 of the charging device 100.

At 302, the device 200 to be charged is placed on or against the display screen 101 of the charging device 100. As discussed above, this means that the device 200 to be charged is placed against or adjacent to the display screen 101 of the charging device 100 within the vicinity (within wireless charging distance) of the induction coil 102.

At 303, the induction coil 102 of the charging device 100 is operated to wirelessly charge the device 200.

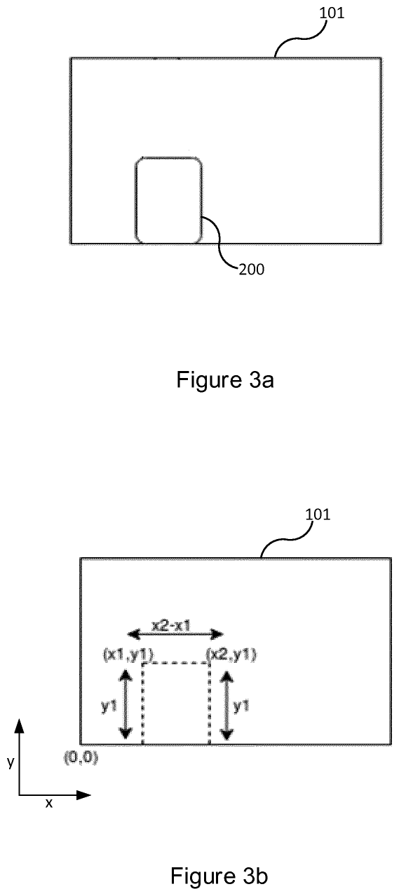

At 304, the charging device 100 determines a portion of the display screen 101 of the charging device 100 that is obscured by the device 200 being charged. If the display screen 101 of the charging device 100 is capable of determining location(s) of the display screen 101 of the charging device 100 which are contacted by the device 200 being charged, then these location(s) can be used by the charging device 100 to determine the obscured portion. This may be the case if for example the display screen 101 of the charging device 100 is a touchscreen. This is discussed in more detail below in relation to FIGS. 3a and 3b. Alternatively or additionally, the obscured portion can be determined using a dedicated sensor such as one or more of a touch sensor; an ultrasonic sensor; an infrared sensor; a proximity sensor; and a pressure sensor. In either case, the obscured portion of the display screen 101 of the charging device is identified by determining a spatial extent of the device 200 being charged on the display screen 101 of the charging device 100.

At 305, the charging device 100 determines a portion of the graphic content which is obscured by the device 200 being charged. This is done using the obscured area determined at 304. That is, the charging device 100 determines a portion of graphic content corresponding to the obscured area. Specifically, the charging device 100 may effectively “crop” the graphic content to leave only the portion of graphic content that was displayed inside the obscured area. In other words, once the part of the display screen 101 of the charging device 100 to be mirrored or replicated on the display screen 201 of the device 200 being charged is known, the corresponding part of the graphic content can easily be fetched via a display driver of the charging device 100. The cropping operation may be a basic data copy of the relevant portion from for example a frame buffer of the display screen 101 of the charging device 100.

Touchscreen displays are capable of determining pixels of an image that are being touched. This means that if the display screen 101 of the charging device 100 is a touchscreen display, as mentioned above, then the charging device 2100 00 can easily determine which parts of the graphic content are being touched by the device 200 being charged. Even if the display screen 101 of the charging device 100 is not a touchscreen, the charging device 100 can determine which parts of the graphic content are obscured by determining pixels of displayed graphic content that are located behind the device 200 being charged, the location of which can be determined by dedicated sensors, as mentioned above. In any case, the blocked part of the graphic content may be retrieved from a frame buffer of the display screen 101 of the charging device 100.

At 306, the charging device 100 sends the obscured portion of the graphic content, determined at 305, to the device 200 being charged. This may be done via, for example, a Bluetooth, NFC, WiFi or other wireless connection. The device 200 being charged receives the obscured portion and displays it on its display screen 201.

The device 200 being charged may move slightly and still be chargeable via the induction coil 102. This may result in a misalignment between the graphic content on the display screen 101 of the charging device 100 and the portion of the graphic content mirrored on the display screen 201 of the device 200 being charged. Hence, determining a portion of the display screen 101 of the charging device 100 that is obscured by the device 200 being charged (at 304), in particular to determine the location of the device 200 over the display screen 101 of the charging device 100, may be performed repeatedly in order to account for the possibility that the device 200 being charged moves relative to the display screen 101 of the charging device 100. This may be carried out at a relatively slow rate, such as for example once a second.

Separately, sending the obscured portion of the graphic content to the device 200 being charged (at 306) may be performed repeatedly at a relatively fast rate, e.g. at or around a refresh rate of the display screen 101 of the charging device 100 or a frame rate of for example video content. This has an advantage that the display screen 201 of the device 200 being charged can be used to better mirror dynamic (moving) content, including for example video content, on the display screen 101 of the charging device 100.

FIGS. 3a and 3b illustrate an example method of determining the obscured portion of graphic content. In this example, the display screen 101 of the charging device 100 is a resistive touchscreen, though in other examples the display screen 101 may be a capacitive touchscreen. The device 200 to be charged is placed on a surface of the charging device 100 (for example, a surface just above the keyboard in the case that the charging device 100 is a laptop computer) and leans against the display screen 101 of the charging device 100. For convenience, consider a coordinate system with the origin placed on the bottom-left hand corner of the display screen 101 of the charging device 100, with a horizontal x-axis and a vertical y-axis.

The resistive charging device touchscreen 101 will identify two inputs located at the top corners of the device 200 to be charged. These inputs are shown as locations (x1, y1) and (x2, y1) in FIG. 3b. With an assumption that the device 200 to be charged is rectangular, it can be determined that the device 200 to be charged obscures the rectangular region of the display screen 101 of the charging device enclosed by points (x1, 0), (x1, y1), (x2, y1), (x2, 0), as shown by the dotted line in FIG. 3b. It is this area which is used to determine the graphic content to be sent to the device 200 being charged, as described above at 305.

In another example, the charging device 100 may determine the obscured portion of the display content based on a known location of the induction coil 102. That is, it can be assumed that the device 200 being charged is blocking a portion of the display screen 101 of the charging device 100 behind which the induction coil 102 is located, because that is where the device 200 being charged must be placed in order to be charged at 303. In other words, the charging device 100 need not measure a location of the device 200 being charged itself, but can simply use a predetermined portion of the display screen 101 of the charging device 100 when determining the obscured content at 305.

In another example, determining a portion of the display screen 101 of the charging device 100 that is obscured by the device 200 being charged (at 304), determining a portion of the graphic content which is obscured by the device 200 being charged (at 305), and sending the obscured portion of the graphic content to the device 200 being charged (at 306) may be performed in response to operating the induction coil 102 to wirelessly charge the device 200 (at 303). That is, determining and sending the obscured content can be performed in response to commencement of wireless charging. This means that the user need only place the device 200 to be charged on the display screen 101 of the charging device 100, and a) the device 200 to be charged will begin charging, and b) the device 200 being charged will begin emulating the obscured content.

Displaying, by the device 200 being charged, the entire obscured portion of graphic content ensures that the user is able to view all the graphic content despite the device 200 being placed against the display screen 101 of the charging device 100. That is, the user can still view graphic content which is not obscured by the device 200 being charged, and graphic content which is obscured is shown on the display 201 of the device 200 being charged.

Alternatively, the device 200 being charged may not display the entire obscured portion of graphic content. For example, there may be a bezel area around the display screen 201 of the device 200 such that the display screen 201 does not cover the entire surface area of the device 200 being charged. In such cases, the edges of the obscured portion of the graphic content which coincide with the bezel may be cropped.

In a first example, cropping may be performed by the device 200 being charged itself following receipt of the obscured portion from the charging device 100. To do so, the device 200 being charged identified which portions of the received graphic content correspond to pixel locations on the display screen 201 of the device 200 and crops all other graphic content before displaying the cropped graphic content.

In a second example, cropping may be performed by the charging device 100 prior to sending the graphic content to the device 200 being charged. In this case, the charging device 100 removes sections of the graphic content which do not corresponding to pixel locations on the display screen 201 of the device 200 being charged (similar to the first example). To do so, the charging device 100 may use specifications of the device 200 being charged either, e.g. stored in a memory at the charging device 100 or received from the device 200 being charged.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A method of operating an electronic device, the method comprising:
operating an induction coil located at a display screen of the electronic device to wirelessly charge another device which is placed against or adjacent the display screen; and
sending, to the other device, graphic content of the display screen of the electronic device that is obscured by the other device for display by the other device whilst charging of the other device is taking place.

2. A method according to claim 1, wherein sending of the graphic content is performed in response to operating the induction coil to wirelessly charge the other device.

3. A method according to claim 2, comprising determining the graphic content by determining a region of the display screen that is obscured by the other device whilst charging of the other device is taking place based on a location of the induction coil in the display screen, the graphic content being graphic content displayed in the obscured region.

4. A method according to claim 2, comprising determining the graphic content by determining a region of the display screen that is obscured by the other device whilst charging of the other device is taking place by detecting at least one point of contact between the other device and the display screen, the graphic content being graphic content displayed in the obscured region.

5. A method according to claim 4, comprising detecting the at least one point of contact using at least one of: a touch sensor; an ultrasonic sensor; an infrared sensor; a proximity sensor; and a pressure sensor.

6. A method according to claim 4, wherein the determining the obscured region comprises detecting a point of contact between a first corner of the other device and the display screen of the electronic device and a point of contact between a second corner of the other device and the display screen of the electronic device.

7. A method according to claim 1, comprising sending the graphic content from a frame buffer of the electronic device to the other device.

8. An electronic device comprising:
a display screen; and
an induction coil located at the display screen for wirelessly charging another device which is placed against or adjacent the display screen in use;
the electronic device being configured to send to said other device graphic content of the display screen that is obscured by said other device for display by said other device whilst charging of said other device is taking place.

9. An electronic device according to claim 8, wherein the electronic device is configured to send the graphic content in response to operating the induction coil to wirelessly charge said other device.

10. An electronic device according to claim 9, wherein the electronic device is configured to determine the graphic content by determining a region of the display screen that is obscured by the said other device whilst charging of said other device is taking place based on a location of the induction coil in the display screen, the graphic content being graphic content displayed in the obscured region.

11. An electronic device according to claim 9, wherein the electronic device is configured to determine the graphic content by determining a region of the display screen that is obscured by said other device whilst charging of said other device is taking place by detecting at least one point of contact between said other electronic device and the display screen, the graphic content being graphic content displayed in the obscured region.

12. An electronic device according to claim 11, wherein the electronic device comprises at least one sensor of: a touch sensor; an ultrasonic sensor; an infrared sensor; a proximity sensor; and a pressure sensor; and the electronic device is configured to detect the at least one point of contact using the at least one sensor.

13. An electronic device according to claim 11, wherein the electronic device is configured to determine the obscured region by detecting a point of contact between a first corner of said other device and the display screen of the electronic device and a point of contact between a second corner of said other device and the display screen of the electronic device.

14. An electronic device according to claim 8, wherein the electronic device is configured to send the graphic content from a frame buffer of the electronic device to said electronic device.

15. A method of operating an electronic device, the method comprising:
wirelessly charging the electronic device via an induction coil located in a display screen of another device when the electronic device is placed against or adjacent the display screen of the other device;
receiving, from the other device, graphic content being displayed on the display screen of the other device and that is obscured by the electronic device whilst charging of the electronic device is taking place; and
causing a display screen of the electronic device to display the received graphic content.

16. A method of operating an electronic device, the method comprising:
operating an induction coil located at a display screen of the electronic device to wirelessly charge another device which is placed against or adjacent the display screen such that the other device obscures an area of the display screen of the electronic device; and
sending, to the other device, graphic content of the display screen of the electronic device for display by the other device whilst charging of the other device is taking place, the graphic content corresponding to the obscured area of the display screen such that the other device can replicate the obscured area of the display screen.

17. A method according to claim 16, comprising sending the graphic content from a frame buffer of the electronic device to the other device.
